(19) United States
(12) Patent Application Publication
(10) Pub. No.: US 2023/0265895 A1
(43) Pub. Date: Aug. 24, 2023

(54) Implement Plug Device

(71) Applicant: Virgil L. Stamps, JR., Hubbard, OR (US)

(72) Inventor: Virgil L. Stamps, JR., Hubbard, OR (US)

(21) Appl. No.: 17/679,563

(22) Filed: Feb. 24, 2022

(51) Int. Cl. F16D 3/84

(52) U.S. Cl. CPC F16D 3/84

(57) ABSTRACT

An implement plug device for plugging an implement yoke so as to keep the yoke clean and free of any debris such as dirt, mud, rust, insects, and the like when not in use. The implement plug device generally includes a main body and a handle portion which is wider than the main body. The main body of the implement plug device generally includes splines extending across at least a portion of the main body for engaging within grooves defined between corresponding splines within the opening of a yoke to prevent rotation of the implement plug device within the yoke. One or more of the splines of the implement plug device may include one or more spline cutouts to engage with corresponding locking members within the yoke. The handle portion will generally include one or more cutouts to aid in removing the implement plug device from the yoke.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND

The described example embodiments in general relate to an implement plug device for plugging an implement yoke so as to keep the yoke clean and free of any debris such as dirt, mud, rust, insects, and the like when the yoke is not in use.

Yokes, such as for insertion of hydraulic lines, are in common use with various types of machinery. Such yokes are commonly used with implements in a wide range of industries, such as agriculture industries. Typically, an implement includes a yoke adapted to receive a hydraulic line so as to power the implement when it is in use. When the implement is not in use, the hydraulic line may be removed, and the opening of the yoke may remain exposed to the elements.

In the past, leaving an opening of a yoke of an implement exposed has presented a number of detriments that can be damaging to operation of the yoke, and thus also the implement to which it is attached. By way of non-limiting example, exposed yoke openings may be intruded upon by various undesirable constituents, such as but not limited to dirt, mud, rust, bee or wasp nests, and the like. Cleaning such yoke openings of such undesirable constituents can waste valuable time, manpower, and money in industries in which time is of the essence (e.g., when harvesting crops).

It would thus be desirable to plug the opening of the yoke of the implement when the implement is not in use (e.g., when no hydraulic line is connected to the yoke).

### SUMMARY

Some of the various embodiments of the present disclosure relate to an implement plug device that can removably plug an opening of a yoke of an implement so as to prevent intrusion within the yoke of undesirable constituents such as dirt, mud, rust, water, pests, and the like. Some of the various embodiments of the present disclosure include a main body including a handle portion. The main body may include a plurality of elongated splines adapted to engage within corresponding slots or grooves within the opening of the yoke. The handle portion may include one or more cutouts to ease removal of the implement plug device from the yoke. The main body and handle portion may be solid (e.g., sealed) so as to prevent any incursions. One or more of the splines may include a spline cutout comprised of an opening adapted to removably engage with a corresponding locking member to removably secure the implement plug device within the opening of the yoke when the yoke is not in use.

There has thus been outlined, rather broadly, some of the embodiments of the present disclosure in order that the detailed description thereof may be better understood, and in order that the present contribution to the art may be better appreciated. There are additional embodiments that will be described hereinafter and that will form the subject matter of the claims appended hereto. In this respect, before explaining at least one embodiment in detail, it is to be understood that the various embodiments are not limited in its application to the details of construction or to the arrangements of the components set forth in the following description or illustrated in the drawings. Also, it is to be understood that the phraseology and terminology employed herein are for the purpose of the description and should not be regarded as limiting.

To better understand the nature and advantages of the present disclosure, reference should be made to the following description and the accompanying figures. It is to be understood, however, that each of the figures is provided for the purpose of illustration only and is not intended as a definition of the limits of the scope of the present disclosure. Also, as a general rule, and unless it is evidence to the contrary from the description, where elements in different FIGS. use identical reference numbers, the elements are generally either identical or at least similar in function or purpose.

### BRIEF DESCRIPTION OF THE DRAWINGS

FIG. 1 is a perspective view of an implement plug device in accordance with an example embodiment.

FIG. 2 is a front view of an implement plug device in accordance with an example embodiment.

FIG. 3 is a rear view of an implement plug device in accordance with an example embodiment.

FIG. 4 is a first side view of an implement plug device in accordance with an example embodiment.

FIG. 5 is a second side view of an implement plug device in accordance with an example embodiment.

FIG. 6 is an end view of an implement plug device in accordance with an example embodiment.

FIG. 7 is an end view of an implement plug device in accordance with an example embodiment.

FIG. 8 is perspective view illustrating insertion of an implement plug device within an implement yoke in accordance with an example embodiment.

FIG. 9 is perspective view illustrating an implement plug device inserted within an implement yoke in accordance with an example embodiment.

FIG. 10 is a sectional view taken along line 10-10 of FIG. 9.

### DETAILED DESCRIPTION

### A. Overview.

Some of the various embodiments of the present disclosure relate to an implement plug device 10 that can be removably inserted within an opening 52 of a yoke 50 so as to plug the yoke 50 and prevent incursions or intrusions that could damage the yoke 50 or a related implement. Generally, the implement plug device 10 will comprise a main body 20 adapted to be inserted within the opening 52 of the yoke 50, and a handle portion 30 adapted to be grasped when inserting or removing the main body 20 into or out of the yoke 50. The main body 20 may include one or more splines 40a, 40b, 40c, 40d, 40e, 40f adapted to engage within corresponding grooves 56 within the yoke's 50 opening 52 to prevent rotation of the implement plug device 10 when so inserted. One or more of the splines 40a, 40b, 40c, 40d, 40e, 40f may include one or more spline cutouts 41a, 41b, 41c, 41d, 41e, 41f in which corresponding locking members 58 may engage so as to releasably lock the implement plug device 10 within the yoke 50.

An exemplary embodiment of the implement plug device 10 may comprise a main body 20 including a first end 22 and a second end 24, wherein the main body 20 is solid. A handle portion 30 may be positioned at the first end 21 of the main body 20, with the handle portion 30 including at least one cutout 32, 34. A plurality of splines 40a, 40b, 40c, 40d, 40e, 40f may extend along the main body 20, with each of the splines 40a, 40b, 40c, 40d, 40e, 40f being spaced apart so as to defined a plurality of slots 42a, 42b, 42c, 42d, 42e, 42f.

The main body 20 and/or the handle portion 30 may be cylindrical. The handle portion 30 may be wider than the main body 20 (e.g., the handle portion 30 may be comprised of a greater diameter than the main body 20). The second end 24 of the main body 20 may be plugged. The handle portion 30 may be solid. The first and second ends 22, 24 of the main body 20 may be sealed. One or more of the splines 40a, 40b, 40c, 40d, 40e, 40f may include a spline cutout 41a, 41b, 41c, 41d, 41e, 41f, which may be comprised of a semi-spherical shape. Each of the splines 40a, 40b, 40c, 40d, 40e, 40f may extend from the handle portion 30 to the second end 24 of the main body 20.

An exemplary method of using the implement plug device 10 may comprise the steps of grasping the handle portion 30, aligning the plurality of splines 40a, 40b, 40c, 40d, 40e, 40f with a plurality of grooves 56 in an opening 52 of the yoke 50, and inserting the main body 20 into the opening 52 of the yoke 50 so as to plug the opening 52 of the yoke 50. A further exemplary method may comprise the step of removing the main body 20 from the opening 52 of the yoke 50.

An exemplary implement plug device system may comprise a yoke 50 adapted to be connected to an implement, with the yoke 50 including an opening 52. An implement plug device 10 may be adapted to be removably inserted within the opening 52 of the yoke 50 so as to plug the yoke 50. Each of the plurality of splines 40a, 40b, 40c, 40d, 40e, 40f may extend outwardly from the main body 20 of the implement plug device 10. The splines 40a, 40b, 40c, 40d, 40e, 40f may be arranged radially around the circumference of the main body 20 at various intervals.

The opening 52 of the yoke 50 may include at least one spherical locking member 58 and at least one of the plurality of splines 40a, 40b, 40c, 40d, 40e, 40f may include at least one spline cutout 41a, 41b, 41c, 41d, 41e, 41f such that the at least one spherical locking member 58 is adapted to engage within the at least one spline cutout 41a, 41b, 41c, 41d, 41e, 41f when the implement plug device 10 is inserted within the opening 52 of the yoke 50.

### B. Main Body.

As shown throughout the figures, the implement plug device 10 may comprise a main body 20 including a first end 21 and a second end 22. The main body 20 of the implement plug device 10 is generally adapted to be removably inserted within the opening 52 of a yoke 50 so as to temporarily cover and plug the opening 52 when the yoke 50 is not in use so as to prevent intrusion by various hazards such as but not limited to weather (e.g., rain, wind, dust), pests (e.g., various insects, rodents, nests, and the like), and any other undesirable constituent or matter that could potentially inhibit operation of the yoke 50.

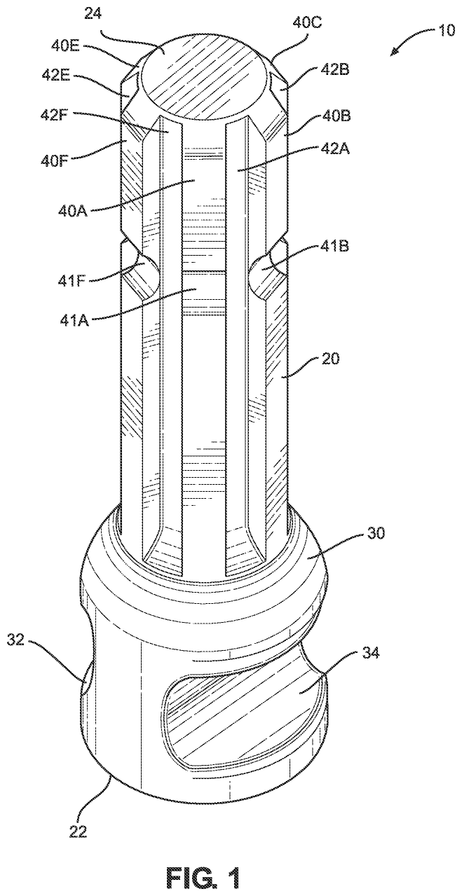

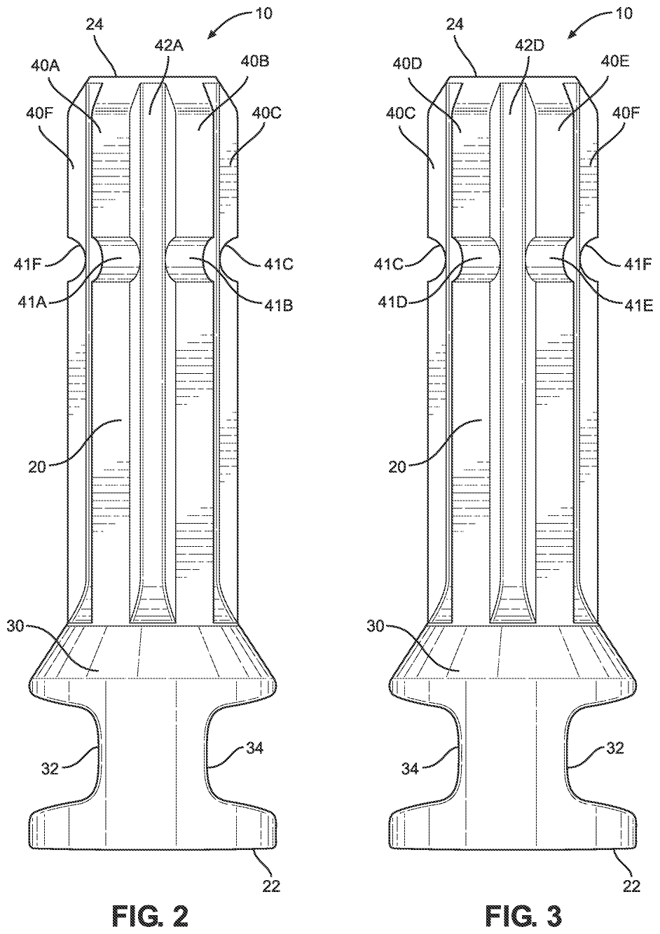

The shape and size of the main body 20 of the implement plug device 10 may vary in different embodiments to suit different types of yokes 50. In the exemplary embodiment shown in the figure, the main body 20 is shaped so as to be removably inserted within a round opening 52 which is common to yokes 50 of various types of implements. Thus, as shown, e.g., in FIGS. 1-10, the main body 20 may comprise a substantially cylindrical shape. However, other shapes may be utilized to suit differently-shaped openings 52.

As best shown in FIGS. 1-5 and 7, the first end 22 of the main body 20 may include a handle portion 30 which is adapted to be grasped by a user when inserted and/or removing the implement plug device 10 into/from the opening 52 of the yoke 50. In some embodiments, such as the exemplary embodiment shown in the figures, the handle portion 30 may be integral with the main body 20. In other embodiments, the handle portion 30 may be fixedly or removably attached to the main body 20.

As best shown in FIGS. 1-5, the handle portion 30 may be comprised of wider dimensions (e.g., circumference, diameter, width) than the main body 20 such that the handle portion 30 may be easily grasped when the remainder of the main body 20 is inserted within the yoke 50. The handle portion 30 may form a flange around the main body 20 such as shown in FIGS. 1-5. However, in some embodiments, the handle portion 30 may be the same dimensions or smaller dimensions than the main body 20.

The second end 24 of the main body 20 of the implement plug device 10 is generally adapted and shaped so as to be removably inserted within the opening 52 of the yoke 50 so as to plug the opening 52. The main body 20, including the first and second ends 22, 24 of the main body 20, may be solid (e.g., without any internal openings). In some embodiments, however, the main body 20 may be hollow, with the first and second ends 22, 24 remaining solid so as to seal off the hollowed opening within the main body 20. In other embodiments, one or both of the first and second ends 22, 24 may include an opening which is concentric with the outer circumference of the main body 20. In the embodiment shown in the figures, the main body 20 and handle portion 30 are each solid (e.g., not hollow), and the ends 22, 24 of the main body 20 are sealed.

As best shown in FIGS. 1-5 and 8-10, the handle portion 30 may include one or more cutouts 32, 34 so as to ease the user in grasping and removing the main body 20 from the opening 52 of the yoke 50. The cutouts 32, 34 may be comprised of indentations formed in one or both sides of the handle portion 30. The shape, size, orientation, and number of cutouts 32, 34 may vary in different embodiments. The cutouts 32, 34 will generally extend into the sides of the handle portion 30, and not the end of the handle portion 30, so as to be easy to grasp for pulling the main body 20 out of the yoke 50.

Continuing to reference FIGS. 1-5 and 8-10, the handle portion 30 is illustrated as including a first cutout 32 and a second cutout 34. The first cutout 32 is shown as comprising a first opening extending into the side of the handle portion 30. Similarly, the second cutout 34 is shown as comprising a second opening extending into the opposite side of the handle portion 30. It should be appreciated that more (e.g., three or more) or less (e.g., one or none) cutouts 32, 34 may be utilized in different embodiments. In some embodiments, rather than the cutouts 32, 34 comprising indentations formed in the handle portion 30, projections may instead be utilized to ease gripping the handle portion 30.

As shown throughout the figures, a flange may be formed on the main body 20 at the transition between the main body 20 and the handle portion 30, such as by virtue of the handle portion 30 being wider than the main body 20. Such a flange is useful for preventing the implement plug device 10 from being fully inserted into a yoke 50 such that it may be not be easily retrieved (e.g., inserted such that the handle portion 30 is flush with the yoke 50).

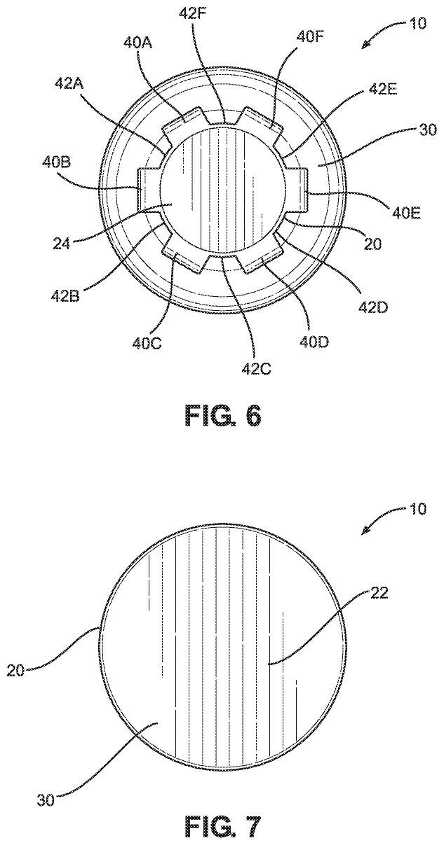

The figures illustrate an embodiment in which both the main body 20 and the handle portion 30 have a circular cross-section such as best shown in FIGS. 6 and 7. As previously mentioned, however, various other shapes may be utilized for the main body 20 and/or the handle portion 30. For example and without limitation, the main body 20 could comprise a circular cross-section, and the handle portion 30 could comprise a square-shaped cross-section. Any other combinations may be utilized, both with respect to the main body 20 and the handle portion 30, to accommodate different types of yokes 50 and related openings 52.

### C. Splines.

As best shown in FIGS. 1-6, the implement plug device 10 may include one or more splines 40a, 40b, 40c, 40d, 40e, 40f adapted to interlock or engage within corresponding grooves 56 in the opening 52 of many standard yokes 50. In the exemplary embodiment shown in the figures, it can be seen that each spline 40a, 40b, 40c, 40d, 40e, 40f is comprised of an elongated projection which runs along the main body 20 of the implement plug device 10. Each of the splines 40a, 40b, 40c, 40d, 40e, 40f of the exemplary embodiment shown in the figures are parallel with respect to each other, though in some embodiments other orientations may be utilized.

Continuing to reference FIGS. 1-6, it can be seen that an exemplary embodiment of the implement plug device 10 may include six such splines 40a, 40b, 40c, 40d, 40e, 40f, including a first spline 40a, a second spline 40b, a third spline 40c, a fourth spline 40d, a fifth spline 40e, and a sixth spline 40f. Such a configuration is ideal for many standardized yokes 50 which have the same number of corresponding grooves 56 within their openings 52. It should be appreciated, however, that the main body 20 of the implement plug device 10 may in various other embodiments include more (e.g., seven or more) or less (e.g., five or less) splines 40a, 40b, 40c, 40d, 40e, 40f to suit different types of yokes 50. Thus, the scope of the present disclosure should not be construed as being limited to the number, positioning, arrangement, and/or orientation of the splines 40a, 40b, 40c, 40d, 40e, 40f shown in the exemplary figures.

With respect to FIGS. 1-6, it can be seen that each spline 40a, 40b, 40c, 40d, 40e, 40f may extend from the handle portion 30 to the second end 24 of the main body 20. Thus, each spline 40a, 40b, 40c, 40d, 40e, 40f is illustrated as extending across the entire length of the main body 20. However, it should be appreciated that the length of each spline 40a, 40b, 40c, 40d, 40e, 40f may vary in different embodiments. In some embodiments, the splines 40a, 40b, 40c, 40d, 40e, 40f may be less than the length of the main body 20. In other embodiments, the splines 40a, 40b, 40c, 40d, 40e, 40f may extend across part or the entire length of the handle portion 30.

The figures illustrate an embodiment in which each spline 40a, 40b, 40c, 40d, 40e, 40f comprises a single, uniform elongated projection extending across the main body 20. It should be appreciated, however, that in some embodiments the splines 40a, 40b, 40c, 40d, 40e, 40f may be segmented (e.g., multiple aligned splines 40a, 40b, 40c, 40d, 40e, 40f may extend across the main body 20 with gaps in between).

Each spline 40a, 40b, 40c, 40d, 40e, 40f shown in the exemplary figures is illustrated as comprising a substantially rectangular-shaped cross-section. It should be appreciated that each spline 40a, 40b, 40c, 40d, 40e, 40f may comprise various other cross-sections in other embodiments, such as but not limited to a circular, semi-circular, triangular, or other shaped cross-sections. Each spline 40a, 40b, 40c, 40d, 40e, 40f may have curved or ramped ends such as shown in the figures, or may comprise flattened ends in some embodiments.

As best shown in FIGS. 1-5, one or more of the splines 40a, 40b, 40c, 40d, 40e, 40f may include one or more spline cutouts 41a, 41b, 41c, 41d, 41e, 41f adapted to removably engage with a corresponding locking member 58 within the opening 52 of the yoke 50 so as to releasably lock the implement plug device 10 within the yoke 50.

The figures illustrate an embodiment in which each spline 40a, 40b, 40c, 40d, 40e, 40f includes a single spline cutout 41a, 41b, 41c, 41d, 41e, 41f. Thus, in the illustrated embodiment, the first spline 40a includes a first spline cutout 41a, the second spline 40b includes a second spline cutout 41b, the third spline 40c includes a third spline cutout 41c, the fourth spline 40d includes a fourth spline cutout 41d, the fifth spline 40e includes a fifth spline cutout 41e, and the sixth spline 40f includes a sixth spline cutout 41f.

It should be appreciated, however, that in some embodiments, only some (e.g., one, two, three, four, or five) of the splines 40a, 40b, 40c, 40d, 40e, 40f include a spline cutout 41a, 41b, 41c, 41d, 41e, 41f. In other embodiments, one or more of the splines 40a, 40b, 40c, 40d, 40e, 40f may include multiple such cutouts 41a, 41b, 41c, 41d, 41e, 41f (e.g., each spline 40a, 40b, 40c, 40d, 40e, 40f could include two or more cutouts 41a, 41b, 41c, 41d, 41e, 41f).

In the figures, it can be seen that each of the spline cutouts 41a, 41b, 41c, 41d, 41e, 41f is illustrated as comprising an indentation formed in a corresponding spline 40a, 40b, 40c, 40d, 40e, 40f. It should be appreciated, however, that in some embodiments, each spline cutout 41a, 41b, 41c, 41d, 41e, 41f may instead be comprised of a gap between multiple aligned splines 40a, 40b, 40c, 40d, 40e, 40f (e.g., multiple, discrete splines 40a, 40b, 40c, 40d, 40e, 40f may be aligned with gaps between them to form the cutouts 41a, 41b, 41c, 41d, 41e, 41f).

While the figures illustrate that each spline cutout 41a, 41b, 41c, 41d, 41e, 41f is comprised of a semi-circular shaped indentation formed in a respective spline 40a, 40b, 40c, 40d, 40e, 40f, it should be appreciated that other shapes may be utilized in different embodiments so as to accommodate differently-shaped locking members 58 within the yoke 50. For example, each spline cutout 41a, 41b, 41c, 41d, 41e, 41f may in some embodiments be comprised of a rectangular cutout.

The positioning of the spline cutouts 41a, 41b, 41c, 41d, 41e, 41f along the length of the respective splines 40a, 40b, 40c, 40d, 40e, 40f may also vary in different embodiments. In the exemplary embodiment best shown in FIGS. 1-5, it can be seen that each spline cutout 41a, 41b, 41c, 41d, 41e, 41f is positioned near the second end 24 of the main body 20 (e.g., approximately a quarter of the length from the second end 24 of the main body 20 to the handle portion 30).

It should be appreciated that, in some embodiments, the spline cutouts 41a, 41b, 41c, 41d, 41e, 41f may be positioned at various other locations along the length of the respective splines 40a, 40b, 40c, 40d, 40e, 40f (e.g., each spline cutout 41a, 41b, 41c, 41d, 41e, 41f may be closer to the handle portion 30 than the second end 24 of the main body 20, or may be centrally-located at the mid-point of the main body 20) so as to accommodate different sizes of implement plug devices 10 and/or yokes 50.

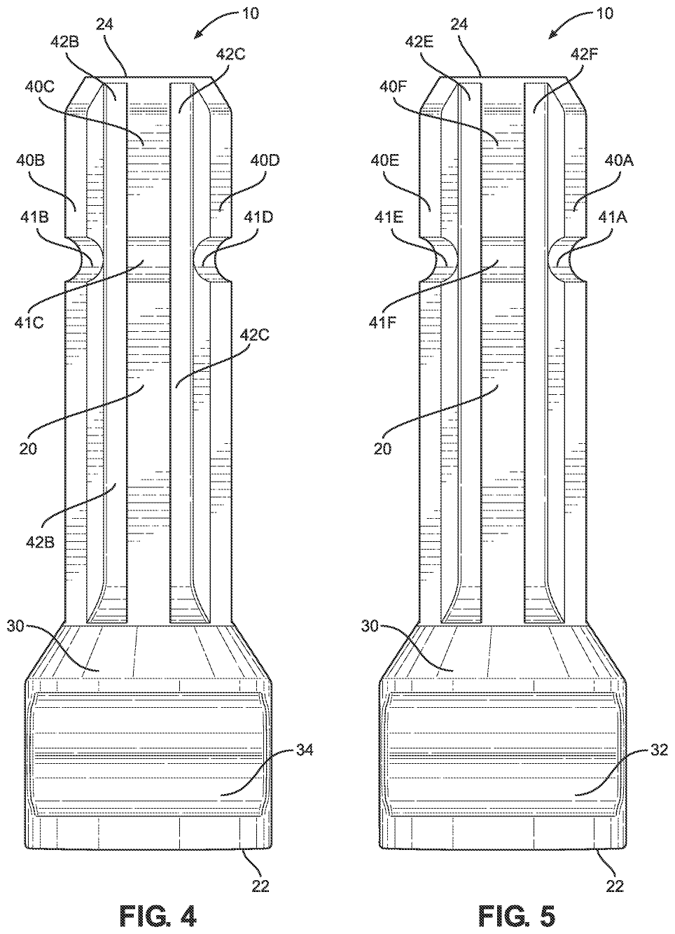

As shown throughout the figures, the splines 40a, 40b, 40c, 40d, 40e, 40f may be spaced-apart in parallel orientation so as to define a plurality of slots 42a, 42b, 42c, 42d, 42e, 42f between the raised splines 40a, 40b, 40c, 40d, 40e, 40f. In the exemplary embodiment shown in FIGS. 4 and 5, it can be seen that a first slot 42a is defined between the first and second splines 40a, 40b, a second slot 42b is defined between the second and third splines 40b, 40c, a third slot 42c is defined between the third and fourth splines 40c, 40d, a fourth slot 42d is defined between the fourth and fifth splines 40d, 40e, a fifth slot 42e is defined between the fifth and sixth splines 40e, 40f, and a sixth slot 42f is defined between the sixth and first splines 40f, 40a. Such slots 42a, 42b, 42c, 42d, 42e, 42f may be adapted to receive and engage with corresponding splines 54 within the opening 52 of the yoke 50.

The use of splines 40a, 40b, 40c, 40d, 40e, 40f and slots 42a, 42b, 42c, 42d, 42e, 42f on the implement plug device 10 may function to prevent rotation of the implement plug device 10 within the opening 52 of the yoke 50, particularly with standard yoke 50 openings 52 that include grooves 56 within which the splines 40a, 40b, 40c, 40d, 40e, 40f may removably engage when the implement plug device 10 is inserted within the yoke 50.

### D. Implement Yoke.

As discussed herein and shown in the figures, the implement plug device 10 is generally adapted to be removably inserted within a yoke 50 so as to plug the yoke 50 when the implement to which the yoke 50 is attached is not in use. The use of the implement plug device 10 when the yoke 50 is not in use prevents various undesirable situations which are known to occur when a yoke 50 opening 52 is left exposed while not in use, such as but not limited to intrusions or incursions by various pests, materials, and the like.

It should be appreciated that the systems and methods shown and described herein may be utilized with a wide range of different types of yokes 50 being connected to a wide range of different types of implements. Such yokes 50 are typically used to connect various types of connectors (e.g., hydraulic, electrical, pneumatic) between an operating device (e.g., a tractor) and an implement. The figures illustrate an exemplary embodiment of a yoke 50 that is not meant to be limiting in any regard.

The yoke 50, and the implement to which the yoke 50 is connected, should not be construed as limited to any particular type. The systems and methods shown and described herein may be utilized in connection with any type of yoke 50 connected to any type of implement known in the art at the time of filing, or conceived of in the future.

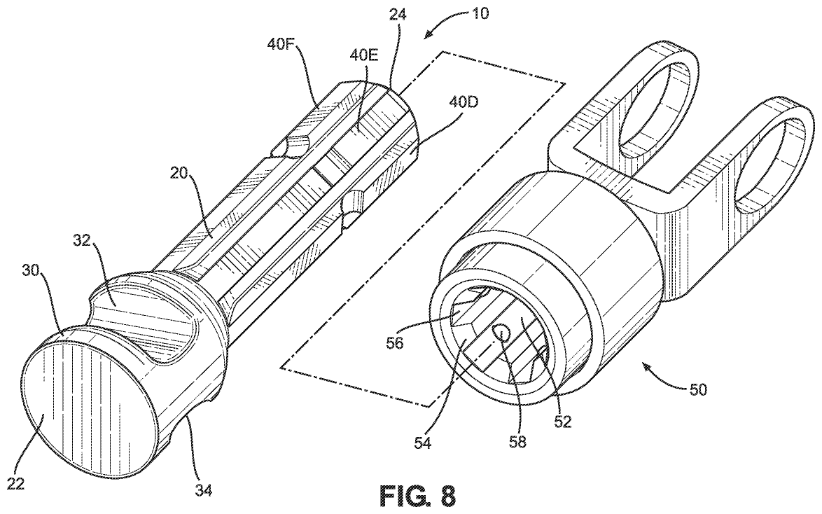

In the exemplary embodiment shown in FIGS. 8-10, it can be seen that an exemplary yoke 50 may include an opening 52 into which a connector may be inserted to connect an implement with a controlling device or machine. The shape, size, and positioning of the opening 52 may vary in different embodiments. It can be seen in FIG. 8 that the opening 52 of the yoke 50 may include a plurality of splines 54 with a plurality of grooves 56 defined between adjacent splines 54. The splines 40a, 40b, 40c, 40d, 40e, 40f of the implement plug device 10 may engage within such grooves 56 (or, put differently, the splines 54 of the yoke 50 may engage within the slots 42a, 42b, 42c, 42d, 42e, 42f of the implement plug device 10) to removably secure the implement plug device 10 within the yoke 50 and prevent the implement plug device 10 from rotating within the yoke 50.

It should be appreciated that the presence, spacing, and/or arrangement of the splines 54 and grooves 56 within the opening 52 of the yoke 50 may vary in different embodiments. The figures illustrate a conventional, standard arrangement of splines 54 and grooves 56 within the opening 52 of an exemplary yoke 50. Various other configurations of yokes 50 may be supported by the implement plug device 10 in different embodiments.

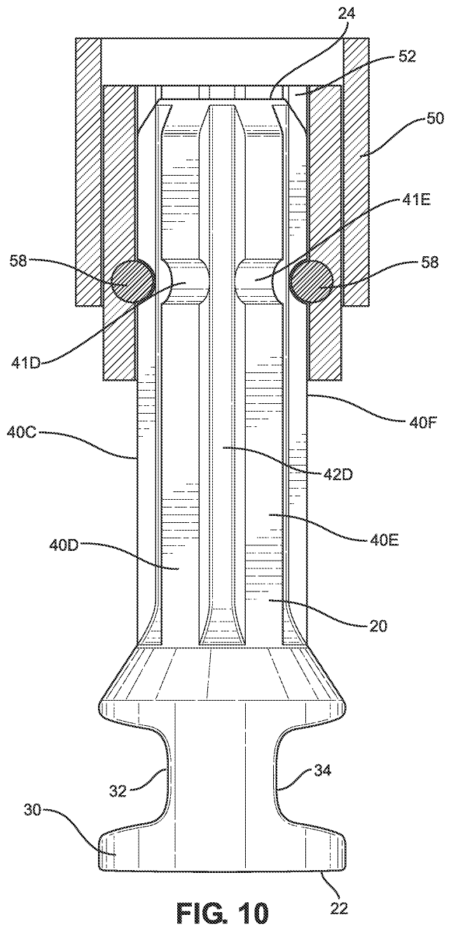

As best shown in FIGS. 8 and 10, the yoke 50 may include one or more locking members 58 adapted to releasably lock the implement plug device 10 within the opening 52 of the yoke 50 when the yoke 50 is not in use. Such locking members 58 are also utilized to releasably lock any connector being inserted into the yoke 50 such that the connector does not break free unintentionally during usage of an implement.

The locking members 58 may comprise spherical or semi-spherical projections within the opening 52 of the yoke 50. Such projections may be adapted to engage within the corresponding spline cutouts 41a, 41b, 41c, 41d, 41e, 41f of the implement plug device 10 when the implement plug device 10 is inserted within the yoke 50 such as shown in FIG. 10. While the locking members are illustrated as comprising a spherical or semi-spherical shape, it should be appreciated that the systems and methods shown and described herein may be utilized with locking members 58 comprised of different shapes than are shown in the exemplary figures.

### E. Operation of Preferred Embodiment.

In use, the implement plug device 10 may inserted within the yoke 50 when the yoke 50 is not in use (e.g., when no connector is inserted within the yoke 50). Generally, yokes 50 have been previously left exposed when not in use, which can lead to various undesirable situations such as but not limited to incursions or intrusions by pests, nests, debris, dust, dirt, water which can lead to rust, and the like.

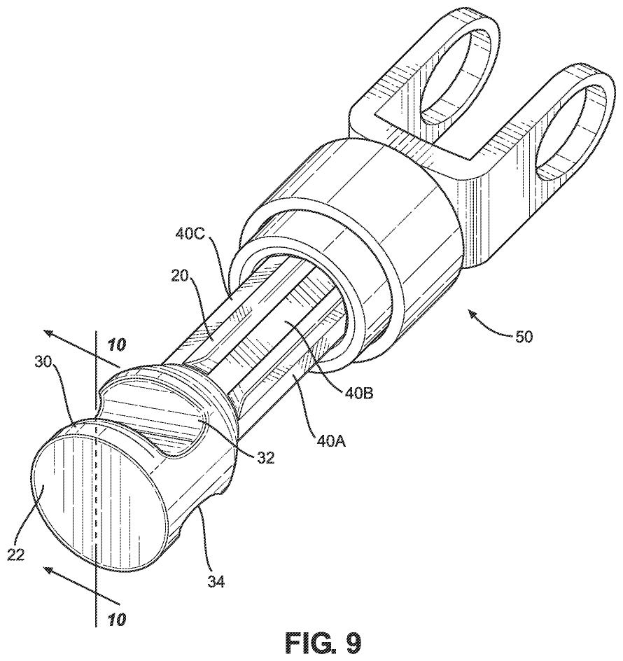

When desired, any connector may be pulled out of the yoke 50 and the yoke 50 (and the implement from which it extends) may be placed into a storage location (e.g., a shed or garage) or onto a vehicle for transport. To prevent incursions that could damage the yoke 50, the implement plug device 10 may be inserted within the yoke 50 prior to or during storage or transport such as shown in FIGS. 9 and 10.

To insert the implement plug device 10, a user will generally grasp the handle portion 30 and position the second end 24 of the main body 20 near the opening 52 of the yoke 50. The user may then rotate the handle portion 30, and thus the interconnected main body 20, so as to align the splines 40a, 40b, 40c, 40d, 40e, 40f with the grooves 56 formed within the opening 52 of the yoke 50 (if any such grooves 56 exist).

Once the implement plug device 10 is so aligned, the user may push on the handle portion 30 to insert the implement plug device 10 into the opening 52 of the yoke 50. The user will generally push on the implement plug device 10 until it is sufficiently inserted such that any locking members 58 of the yoke 50 engage within the corresponding spline cutouts 41a, 41b, 41c, 41d, 41e, 41f of the implement plug device 10. The yoke 50 may then be stored or transported as-needed without concern of any incursions or intrusions that could damage the yoke 50 or related implement.

When it is desired to remove the implement plug device 10, a user may grasp the handle portion 30 and pull outwardly such that the locking members 58 disengage from the spline cutouts 41a, 41b, 41c, 41d, 41e, 41f and the main body 20 may be removed from the opening 52 of the yoke 50. If extra leverage is needed, the user may insert his or her fingers within one or both cutouts 32, 34 of the handle portion 30. Generally, a lubricant may be applied to one or both of the opening 52 and/or main body 20 to ease insertion and removal of the implement plug device 10. The lubricant may be applied each time the implement plug device 10 is inserted and/or removed, or may be periodically applied when the previous lubricant has worn off.

Unless otherwise defined, all technical and scientific terms used herein have the same meaning as commonly understood by one of ordinary skill in the art to which this invention belongs. Although methods and materials similar to or equivalent to those described herein can be used in the practice or testing of the various embodiments of the present disclosure, suitable methods and materials are described above. All patent applications, patents, and printed publications cited herein are incorporated herein by reference in their entireties, except for any definitions, subject matter disclaimers or disavowals, and except to the extent that the incorporated material is inconsistent with the express disclosure herein, in which case the language in this disclosure controls. The various embodiments of the present disclosure may be embodied in other specific forms without departing from the spirit or essential attributes thereof, and it is therefore desired that the various embodiments in the present disclosure be considered in all respects as illustrative and not restrictive. Any headings utilized within the description are for convenience only and have no legal or limiting effect.

What is claimed is:

1. An implement plug device, comprising:
a main body including a first end and a second end, wherein the main body is solid;
a handle portion at the first end of the main body, wherein the handle portion includes at least one cutout; and
a plurality of splines extending along the main body, wherein each of the plurality of splines is spaced apart so as to define a plurality of slots.

2. The implement plug device of claim 1, wherein the main body is cylindrical.

3. The implement plug device of claim 2, wherein the handle portion is cylindrical.

4. The implement plug device of claim 1, wherein the handle portion is wider than the main body.

5. The implement plug device of claim 1, wherein the second end of the main body is plugged.

6. The implement plug device of claim 1, wherein the handle portion is solid.

7. The implement plug device of claim 1, wherein the first end and the second end of the main body are sealed.

8. The implement plug device of claim 1, wherein one or more of the plurality of splines includes a spline cutout.

9. The implement plug device of claim 8, wherein the spline cutout of the one or more of the plurality of splines is comprised of a semi-spherical shape.

10. The implement plug device of claim 1, wherein each of the plurality of splines extends from the handle portion to the second end of the main body.

11. A method of using the implement plug device of claim 1, comprising the steps of:
grasping the handle portion;
aligning the plurality of splines with a plurality of grooves in an opening of a yoke; and
inserting the main body into the opening of the yoke so as to plug the opening of the yoke.

12. The method of claim 11, further comprising the step of removing the main body from the opening of the yoke.

13. An implement plug device system, comprising:
a yoke adapted to be connected to an implement, wherein the yoke includes an opening; and
an implement plug device, comprising:
a main body including a first end and a second end;
a handle portion at the first end of the main body, wherein the handle portion includes at least one cutout; and
a plurality of splines extending along the main body, wherein each of the plurality of splines is spaced apart so as to define a plurality of grooves, and wherein each of the plurality of splines extends from the handle portion to the second end of the main body;
wherein the implement plug device is adapted to be removably inserted within the opening of the yoke so as to plug the yoke.

14. The implement plug device system of claim 13, wherein the main body and the handle portion are each cylindrical.

15. The implement plug device system of claim 14, wherein the handle portion is comprised of a greater diameter than the main body.

16. The implement plug device system of claim 13, wherein the at least one cutout is comprised of an opening in at least one side of the handle portion.

17. The implement plug device system of claim 13, wherein the main body and the handle portion are each solid.

18. The implement plug device system of claim 13, wherein each of the plurality of splines extends outwardly from the main body of the implement plug device.

19. The implement plug device system of claim 13, wherein the opening of the yoke includes at least one spherical locking member, wherein at least one of the plurality of splines includes a spline cutout, and wherein the at least one spherical locking member of the opening of the yoke is adapted to engage within the spline cutout when the implement plug device is inserted within the opening of the yoke.

20. An implement plug device system, comprising:
a yoke adapted to be connected to an implement, wherein the yoke includes an opening, and wherein the opening of the yoke includes at least one spherical or semi-spherical locking member; and
an implement plug device, comprising:
a main body including a first end and a second end, wherein the main body is cylindrical, and wherein the main body is solid;
a handle portion at the first end of the main body, wherein the handle portion includes a first cutout and a second cutout, wherein the first cutout is comprised of a first opening within a first side of the handle portion, and wherein the second cutout is comprised of a second opening within a second side of the handle portion; and
a plurality of splines extending along the main body, wherein each of the plurality of splines is spaced apart radially around the main body so as to define a plurality of grooves, wherein each of the plurality of splines extends from the handle portion to the second end of the main body, and wherein at least one of the plurality of splines includes a spline cutout;
wherein the implement plug device is adapted to be removably inserted within the opening of the yoke so as to plug the yoke, and wherein the at least one spherical or semi-spherical locking member of the opening of the yoke is adapted to engage within the spline cutout when the implement plug device is inserted within the opening of the yoke.
